(19) United States
(12) Patent Application Publication
(10) Pub. No.: US 2012/0135808 A1
(43) Pub. Date: May 31, 2012

(54) Local Database Gaming System Techniques

(76) Inventors: Michael H. D'Amico, Las Vegas, NV (US); Steven A. Weiss, Henderson, NV (US); Tara L. Young, Las Vegas, NV (US); Alan G. Sheldon, North Las Vegas, NV (US); Lattamore Osburn, Las Vegas, NV (US)

(21) Appl. No.: 13/304,586

(22) Filed: Nov. 25, 2011

Related U.S. Application Data
(63) Continuation of application No. 09/981,459, filed on Oct. 16, 2001, now abandoned.

(51) Int. Cl. G06F 19/00

(52) U.S. Cl. 463/42

(57) ABSTRACT

A gaming system (10) includes gaming machines (100, 102, 104, 106) arranged to receive input data and to generate output data. A central database (24) stores the input data and the output data. A data processing unit 40 includes a local database (46). Unit 40 polls the gaming machines to obtain the output data over a network (12), stores the output data in the local database, transmits the output data over the network to the central database and arranges the data in a format useable by report generating software, obtains the input data from the central database, and stores the input data in the local database for use by the gaming machines.

### BACKGROUND OF THE INVENTION

This invention relates to gaming systems, and more particularly relates to storage and processing of data related to such systems.

A large gaming casino typically employs thousands of gaming machines that can be operated simultaneously. The gaming machines generate considerable transaction data that needs to be stored and analyzed. Typically, the transaction data is transmitted from each gaming machine to a central database and processing system, which may receive a large amount of data during a short time period. Experience has shown that the transaction data may be lost due to network congestion or to inadequate processing speed to accommodate the large volume of transaction data.

A typical arrangement for transmitting transaction data from gaming machines to a central database and processing system is shown in FIG. 1. Gaming machines 100P, 102P, 104P and 106P generate transaction data that is transmitted over networks 14P, 15P, 16P and 17P, respectively, to a data port unit 45P under control of a poller algorithm 44P executed by a central processing unit (CPU) 42P that immediately passes the transmitted data through a network interface 48P and a network 18P to a central database and processing system 24P. The CPU and network form a bottleneck that may lose transaction data, or many slow the operation of the system to an unacceptably low rate.

The central processing system 24P typically uses report-generating software to generate reports of gaming activity by the gaming machines. The software requires that the data in the tables of the central database be arranged in a format useable by the software. In the past, the formatting of the data in a format useable by the report generating software has necessitated more than two dozen steps requiring human intervention. These steps are time consuming and require highly trained personnel.

The present invention addresses the foregoing problems and provides solutions.

### BRIEF SUMMARY OF THE INVENTION

A first apparatus form of the invention is useful in a gaming system comprising a plurality of gaming machines and a first database arranged to store input data and the output data. In such an environment, improved data storage and communications can be provided between the gaming machines and the first database by providing apparatus comprising a network and a data processing unit including a second database. The data processing unit is arranged to poll the gaming machines to obtain the output data over the network, to store the output data in the second database, to transmit the output data over the network to the first database, to obtain the input data from the first database, to store the input data in the second database, and to transmit at least a portion of the input data from the second database to the gaming machines over the network.

A second apparatus form of the invention is useful in a gaming system comprising a plurality of gaming machines arranged to generate output data in a first format. In such an environment, an audit report is generated by providing apparatus comprising a network and a processing system arranged to store an audit program capable of generating the audit report from the output data formatted into a second format, to poll the gaming machines to obtain the output data in the first format over the network, to process the output data into the second format without human intervention, to store the output data in the second format and to generate the audit report from the output data in the second format.

A first method form of the invention is useful in a gaming system comprising a plurality of gaming machines and a first database arranged to store input data and output data. In such an environment, data storage and communications between the gaming machines and the first database are provided by steps comprising polling the gaming machines to obtain the output data, storing the output data apart from the first database, transmitting the stored output data to the first database, obtaining the input data from the first database, storing the input data apart from the first database and transmitting at least a portion of the input data stored apart from the first database to the gaming machines.

A second method form of the invention is useful in a gaming system comprising a plurality of gaming machines arranged to generate output data in a first format. In such an environment, an audit report can be generated by steps comprising storing an audit program capable of generating the audit report from the output data formatted into a second format, polling the gaming machines to obtain the output data in the first format, processing the output data into the second format without human intervention, storing the output data in the second format, and generating the audit report from the output data in the second format.

A third method form of the invention is useful in a gaming system comprising a plurality of gaming machines and a first database arranged to store input data and output data. In such an environment, data storage and communications are provided between the gaming machines and the first database by steps comprising dividing the gaming machines into a first group and a second group, polling the gaming machines in the first group to obtain first output data, storing the first output data apart from the first database, transmitting the stored first output data to the first database, polling the gaming machines in the second group to obtain second output data, storing the second output data apart from the first database and apart from the first output data, transmitting the stored second output data to the first database, obtaining from the first database first input data comprising a portion of the input data for use in the first group of games, storing the first input data apart from the first database, transmitting at least a portion of the first input data stored apart from the first database to the first group of gaming machines, obtaining from the first database second input data comprising a portion of the input data for use in the second group of games, storing the second input data apart from the first database and apart from the first input data, and transmitting at least a portion of the second input data stored apart from the first database and apart from the first input data to the second group of gaming machines.

By using techniques of the foregoing type, gaming data may be stored, processed and formatted for report generation with a degree of ease and reliability previously unavailable.

### BRIEF DESCRIPTION OF THE DRAWINGS

FIG. 1 is a schematic block diagram of a prior art technique for communicating data between gaming machines and a central database and processing system.

FIG. 2 is a schematic block diagram of one form of gaming system made in accordance with the invention employing one form of network.

FIG. 3 is a schematic block diagram of one of the gaming machines shown in FIG. 2.

FIG. 4 is a top plan view of one form of ticket printed by the system shown in FIG. 2.

FIG. 5 is a schematic block diagram of a first alternative form of network for the gaming system shown in FIG. 2.

FIG. 6 is a schematic block diagram of a second alternative form of network for the gaming system shown in FIG. 2.

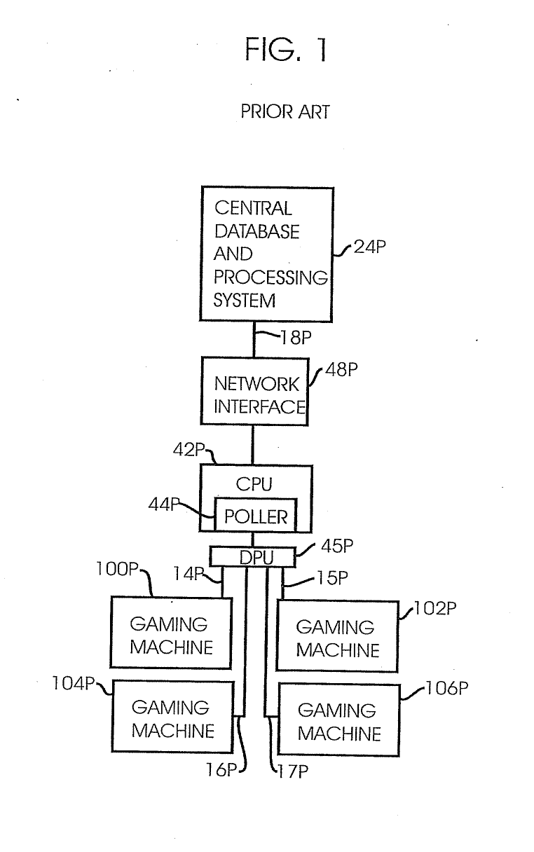

### DETAILED DESCRIPTION OF THE INVENTION

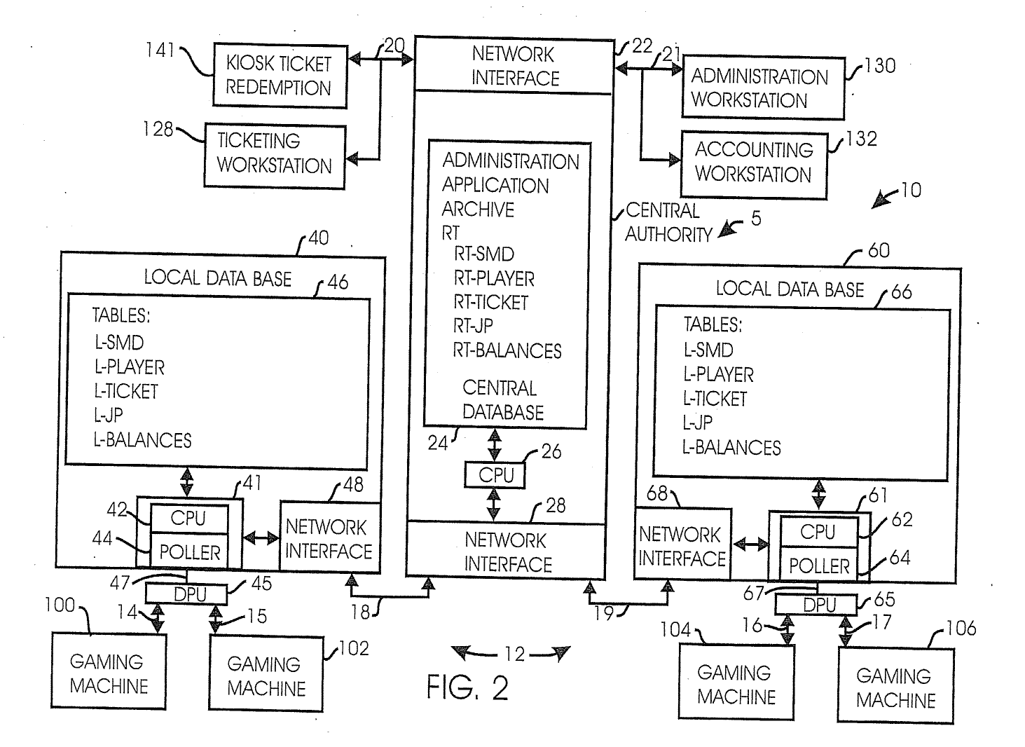

Referring to FIG. 2, gaming system 10 includes several gaming machines (“games”), such as gaming machines 100, 102, 104 and 106, that receive input data and generate output data. The data is transmitted over a network 12, which includes subnetworks 14-19 using, for example, RS485 serial protocol and data port units (DPUs) 45 and 65. Gaming machines 100-106 may be implemented, for example, as slot machines, video poker machines, video roulette machines, and the like.

Network 12 also may be configured as an Ethernet network employing TCP/IP protocol. With TCP/IP protocol, the use of DPUs 45 and 65 is optional. One form of an Ethernet network 12 is shown in FIG. 5.

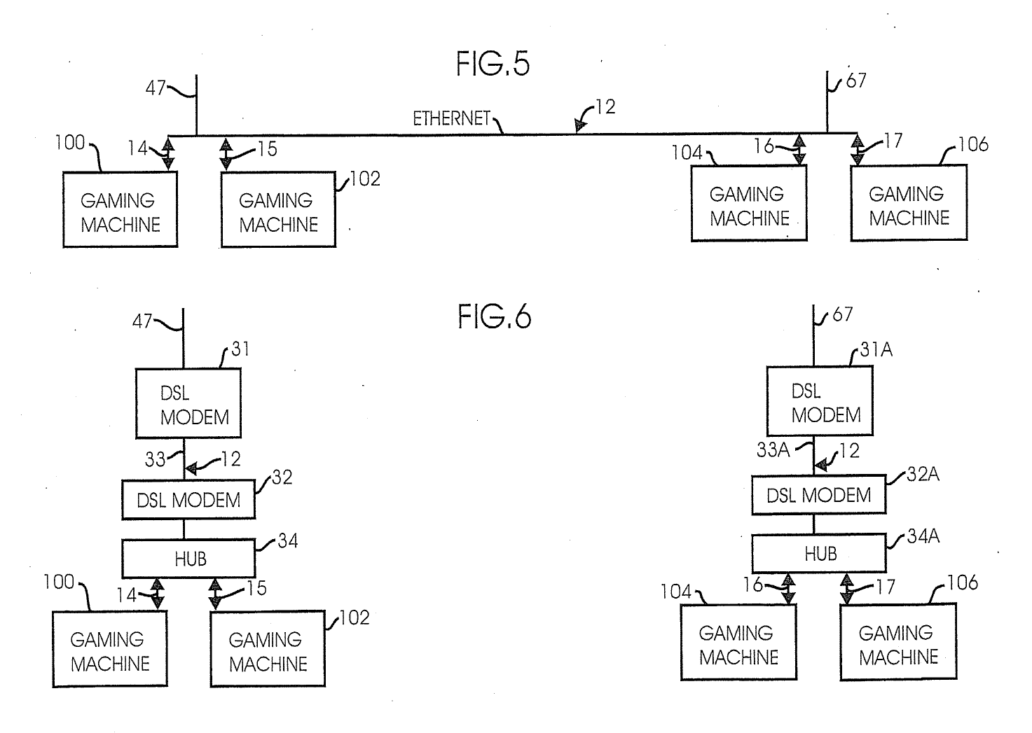

As another alternative, network 12 may comprise a digital subscriber line (DSL) network of the type shown in FIG. 6. In this alternative, DSL modems 31 and 32 are connected to opposite ends of a DSL subnetwork 33 comprising twisted pair cabling. A hub 34 separates the data channels for gaming machines 100 and 102 and transmits the appropriate data on subnetworks 14-15 as shown. As shown in FIG. 6, components 31A-34A, which are like components 31-34, provide a DSL connection between subnetworks 67 and 16-17 as shown.

Referring to FIG. 2, a central authority 22 stores the input data for gaming machines and output data from gaming machines 100-106 in a central database 24. A central processing unit (CPU) 26 operates through a network interface 28 and subnetworks 18-19 to enable communication with local data processing units 40 and 60. Subnetworks 18-19, central authority 22 and local data processing units 40 and 60 form a processing system 5.

Units 40 and 60 are organized by dividing games 100-106 into groups and assigning a unit like units 40 and 60 to each group. By using such architecture, transaction data from each group of games can be temporarily stored in the units. The units can be structured so that they always have sufficient capacity and speed to accommodate any amount of data generated by the games. As a result, the overall system never becomes overloaded or bogged down. In addition, no data is lost if networks 18-19 are disabled or if central authority 22 is inoperable. Faster and more accurate operation results.

Units 40 and 60 also are designed to store data from database 24 that may be needed by games 100-106. Such data will be readily available for use by the games even if networks 18 and 19 are disabled or if central authority is disabled temporarily. As a result of these features, the gaming facility will remain operational even if some of its networks or central authority malfunction.

Unit 40 may be implemented as a personal computer employing a central processing unit (CPU) 42 that executes a poller algorithm 44, which polls gaming machines 100 and 102 to obtain output data over subnetworks 14 and 15 through data port unit (DPU) 45, a message/transaction buffering device. CPU 42 routes and buffers data, and communicates through poller 44 with game machines 100 and 102. Poller 44 transfers data between game machines 100 and 102 and a local database 46. The game output data stored in local database 46 is transmitted at regular time intervals to central authority 22 through a network interface 48 and subnetwork 18 and is stored in central database 24. Some of the input data in central database 24 also is transmitted over subnetwork 18 to local database 46 and is stored in database 46. On occasion, one of gaming machines 100 and 102 requires transmission of input data stored in local database 46, and the input data is sent to the gaming machine under control of CPU 42.

Unit 60 includes a PC 61 employing a central processing unit (CPU) 62 that executes a poller algorithm 64, which polls gaming machines 104 and 106 to obtain output data over subnetworks 16 and 17 through data port unit (DPU) 65, a message/transaction buffering device.

CPU 62 routes and buffers data, and communicates through poller 64 with game machines 104 and 106. Poller transfers data between game machines 104 and 106 and local database 66. The game output data stored in a local database 66 is transmitted periodically to central authority 22 through a network interface 68 and subnetwork 19, and is stored in central database 24. Some of the input data in central database 24 also is transmitted over subnetwork 19 to local database 66 and is stored in database 66. On occasion, one of gaming machines 104 and 106 requires transmission of input data stored in local database 66, and the input data is sent to the gaming machine under control of CPU 62.

Support systems connect to central authority 22 through networks 20 and 21. The support systems include a ticketing workstation 128, an administration workstation 130, an accounting workstation 132 and other workstations, such as a kiosk ticket redemption workstation 141.

Accounting workstation 132 stores gaming audit report generating software that generates gaming audit reports from gaming transaction data formatted in an audit format.

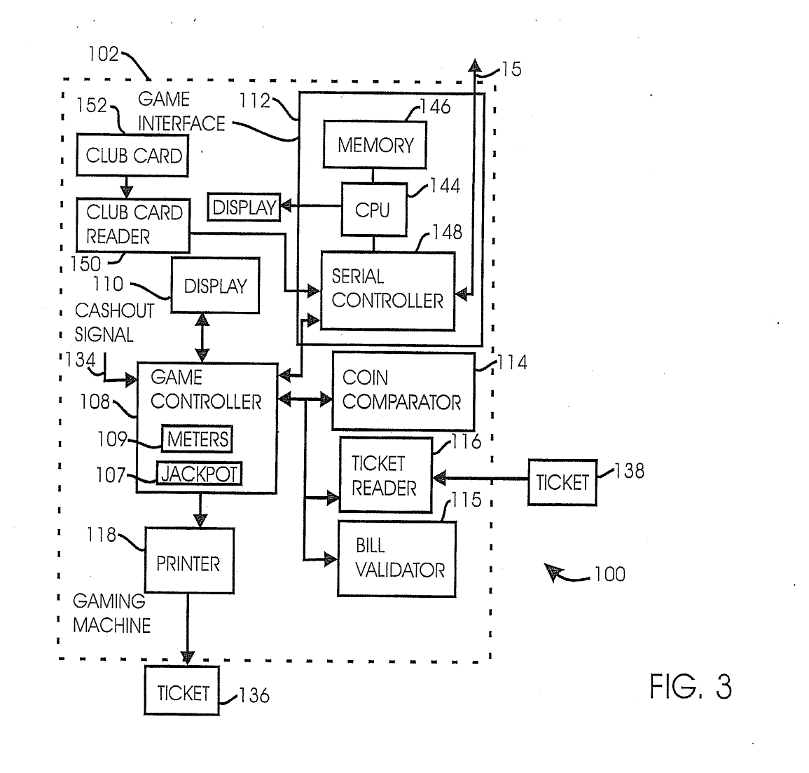

Gaming machine 102 is exemplary of gaming machines 100-106 and will be described in more detail in connection with FIG. 3.

Referring to FIG. 3, gaming machine 102 includes a game controller 108, a display 110, and a game interface 112. Game interface 112 may include, for example, an RS485 interface such as that implemented by a Sentinel™ Interface from Casino Data Systems. Other interfaces and network architectures (e.g., Ethernet, parallel port, and the like) may be substituted. Game interface 112 may implement, for example, the IGT Gaming SAS communication protocol or the CDS GDAP™ communication protocol for communication with gaming machine 102, or a custom communication protocol. Game interface 112 includes a CPU 144, a program and data memory 146 and a serial controller 148. Gaming machine 102 also typically includes a coin comparator 114, a bill validator 115, a ticket reader 116, and a ticket printer 118. The functionality of the ticket reader 116 and bill validator 115 is often incorporated into a single device.

Game controller 108 includes meters that generate and store transaction data obtained from gaming machine 102, such as a meter function 109 that generates and stores meter data recording various gaming transactions of game 102 and a jackpot function 107 that generates and stores jackpot data. The transaction data (e.g., meter data and jackpot data) are transmitted to memory 146 under the control of CPU 144. Memory 146 stores the transaction data in tables, such as a meter table L-SMD and a jackpot table L-JP.

The game controller 108 is responsive to a cashout signal 134 to print a ticket 136 on paper, or other suitable material. Previously printed tickets (e.g., a ticket 138) may be redeemed by the gaming machines 100-106.

The game controller 108 is responsible for operation of the gaming machine 102. Thus the game controller may include a microprocessor, memory, game software, and support circuitry to implement a slot machine or other type of game. The display 110 presents to the player a representation of the pending credit in the gaming machine 102 (e.g., $455.50). During play, the game controller 108 tracks the pending credit according to the rules of the game and the interaction with the player (including the deposit of additional funds via coin comparator 114, bill validator 115 or ticket reader 116), and further monitors for assertion of the cashout signal 134. Thus, central authority 22 does not monitor the pending credit in each of gaming machines 100-106, because each of gaming machines 100-106 tracks the pending credit locally and independently of central authority 22.

In response to the cashout signal 134, the game controller 108 prints the ticket 136 which may be redeemed later at any of gaming machines 100-106 or at independent workstations, such as workstation 141, with ticket readers. The cashout signal 134 may be generated by a player-actuated switch, touchscreen input, or the like. The game controller 108 prints the ticket 136 with a pre-loaded ticket validation number obtained from the central authority 22, stored in local database 46 and then transferred to memory 146. Alternatively, the pre-loaded ticket validation number may be generated by poller 44, CPU 144 or game controller 108, and may be stored in memory in preparation for the next ticket printing event. The ticket validation number also may be generated by game controller 108 during the ticket printing event.

The central database 24 stores data obtained from the gaming machines 100-106, as well as locally generated validation numbers and ticket status. The ticketing workstation 128 redeems tickets for the amount specified by central authority 22, but does not enter a cash amount in any computer memory in return for currency, and does not print any tickets readable by ticket reader 116. Administration workstation 130 edits configuration information, and accounting workstation 132 produces reports, including gaming audit reports.

Game 102 also includes a club card reader 150 that can read a MAG number located on a magnetic strip of a club card 152, which may comprise a smart card. The MAG number is unique for each player. Card 152 also sometimes bears a player ID number that is human readable, but is not machine readable. The card reader sends the MAG number to central authority, which converts the MAG number to an OCR number. This feature prevents any potential misuse due to fraudulent creation of a bogus club card. Database 24 maintains a table that correlates OCR numbers with player ID numbers. An example of misuse prevented or inhibited by converting the MAG number to an OCR number is as follows. The clerks at the workstations generally have access to the OCR numbers, but not the MAG numbers. As a result, a person operating outside system 10 could not duplicate a new player card with a MAG number corresponding to an existing club card. If such a person could duplicate an existing club card, the person may be tempted to use the duplicate card to cash out a player's account. The conversion of the MAG number to an OCR number is an important feature that inhibits such temptation.

Central authority 22 translates an OCR number to a corresponding player ID number. This feature allows a single player ID number to identify more than one OCR number. The player ID number can be used by the central authority to address the value of an account corresponding to the player ID number. Thus, the central authority keeps no account value corresponding to the MAG number or OCR number; it only keeps an account value corresponding to the player ID number, correlated with the OCR number by a table.

Neither the central authority nor any of workstations 128, 130, 132 or 141 has a bill validator or a coin comparator, and none has any capability for entering the value of currency received from a player.

Club cards are generated by having a player fill out a form and submitting the form to a clerk at a workstation that is equipped with a card creator (not shown). Typically, a card creator is located at only one or two work stations within a gambling facility. The clerk keys information into the workstation, and the information is transmitted to central authority 22, which then generates an OCR number, corresponding MAG no. and player ID number for the creation of a new club card. The OCR number and player ID number are stored in the database 24 in the manner previously described. The central authority then causes the card creator to create a new club card with the stored player ID number and MAG number. Thus, the OCR number is not stored in database 24 by having the new club card read by a card reader. Once the MAG, OCR and player ID numbers are created, they cannot be changed by a person operating outside system 10.

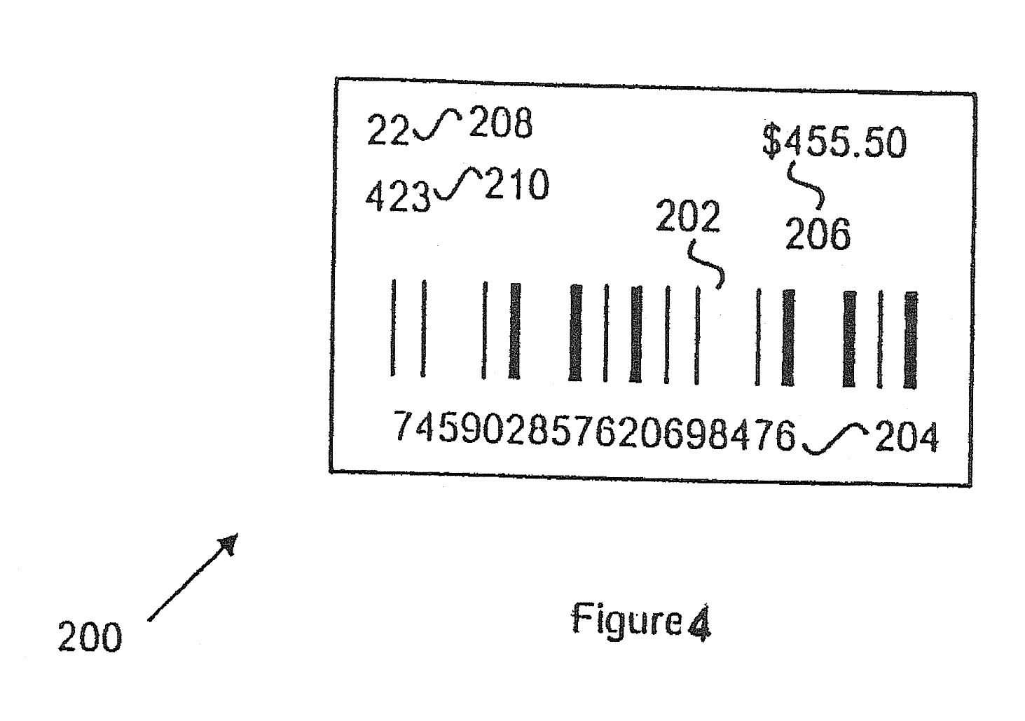

Turning next to FIG. 4, a ticket 200 includes a validation number bar code 202 (e.g., in Code 205 format), a validation number in human intelligible format 204, and a human intelligible cash out amount 206. The ticket 200, as shown, also includes a machine number 208 and a ticket number 210 (e.g., a sequential ticket number generated in the gaming machine 102). Validation number bar code 202 is a machine-readable representation of a pre-loaded validation number, but validation number bar code 202 does not encode other information (e.g., the cash out amount). Additional information may be printed on the ticket 136, including a date/time of cashout, casino name, ticket expiration date, and the like.

Central database 24 stores a real time (RT) database, an administration database, an application database and an archive database.

Units 40 and 60 are identical and may be understood from the following description of unit 40. Unit may be implemented by personal computer (PC) 41 configured as an SQL server for storing gaming data in relational databases, including relational tables. PC 41 polls gaming machines 100-102 and updates local database 46 and central database 24. Communications to gaming machines 100-102 may be an RS-485 connection to DPU 45 and to the gaming machines over subnetworks 14-15. Alternatively, communications may be by TCP/IP from unit 40 directly to the gaming machines, as shown in FIG. 5.

Unit 40 has a local SQL database, which contains all necessary information for unit 40 to process transactions from gaming machines 100 and 102 except for transactions involving balances in player accounts stored in central authority 22 and redemption of ticket 138. Gaming machines 100 and 102 include meters, such as meters 107 and 109, that maintain transaction data concerning gaming transactions on the machines. The transaction data is stored in memory 146 (FIG. 2). Poller 44 writes all transaction data from gaming machines 100 and 102 to local relational tables, such as meter and player tables, in local database 46, which form relational databases. For example, meter data is stored in table L-SMD, jackpot data is stored in table L-JP, ticket data is stored in table L-TICKET and player data is stored in table L-PLAYER. Unit 40 obtains data from the RT and administration databases in central database 24 and posts all gaming transaction data from local database 46 to the RT database in central database 24.

Unit 40 performs three processes: administrator, poller and data mover.

The administrator posts transactions to the RT database indicating that unit 40 is processing transactions. The administrator also communicates with diagnostic application software, responding with real-time information about DPU 45 (FIG. 2), interface 112 (FIG. 3), and the network 12 (FIG. 2).

The poller processes transaction data from DPU 45 and posts all transaction data to local database 46. The poller uses data required by games 100 and 102 from the local database 46 whenever possible. The poller obtains data relating to balances in player accounts and ticket 138 from the RT database in central database 24 and stores the data in database 46. The transaction data stored in games 100-106 is formatted in a format unacceptable to the gaming audit report generating software stored in workstation 132. The poller formats the transaction data into the audit format acceptable to the gaming audit report generating software before storing the data in the tables in database 46.

The poller also obtains game status information such as Door Open/Close, Tilts, Game Meters, Diagnostic Status, Sub Game Meters, Jackpots, Bills In, Ticket Redemption and Tickets Out and inserts these transactions in the local database (e.g., 46, FIG. 2). The poller also verifies the status of tickets in the RT database of central database 24 for the ticket redemption process.

The poller also obtains requests from the player of gaming machine 102. Player card in and player card out operations initiated when the player inserts club card 152 or removes club card 152 (FIG. 3) create player ratings that are inserted into local database 46 (FIG. 2). The poller sends information to interface 112 (FIG. 3) about the player in order to process a player rating, such as player point bonuses or player level. The poller will perform Personal Banker transactions requested by the player. These transactions will be performed on the RT database in central database 24. The player may request a service transaction, such as a request for a drink.

The poller also responds to requests from an employee of the gaming facility. Employee cards trigger the poller to obtain meters and trigger events such as coin or cash drop.

The poller also passes information to interface 112 (FIG. 3), such as current date and time, custom messages, game information/setup and player bonuses about to begin or end.

The data mover queries the administration database on a regular time interval and updates the local database 46 with all changes. The data posted by the data mover includes system setup parameters, bonus setup, and gaming machine master data.

The data mover involves several processes run simultaneously on unit 40: meter post, ticket post, jackpot post, and player post. These processes automatically execute on unit 40. Steps performed by data mover are described in the following paragraphs.

Meter post takes transaction data from the local meter table stored in database 46, updates the RT database in central database 24 and deletes the moved data from the from the local meter table L-SMD in database 46.

Ticket post takes transactions from a local ticket table L-TICKET stored in local database 46, posts the transactions to the RT database in central database 24 and deletes the transactions from the ticket table in local database 46.

Jackpot post takes transactions from a local L-JP table, posts the transactions to the RT database in central database 24 and deletes the transactions from the local L-JP table.

Player post takes transactions from a local player table L-PLAYER, posts the transactions to the RT-PLAYER database in central database 24 and deletes the transactions from the local Player table only after a Card-Out transaction has been processed (e.g., after the player using game 102 has exited the game and has removed his card 152 from reader 150), or on regular time intervals to prevent data loss.

The data mover transfers all information stored in local database 46 by the poller to the RT database in central database 24.

Referring to FIG. 2, in operation, poller 44 polls gaming machines 100 and 102 to obtain ticket, player, meter and jackpot transaction data which is formatted into the audit format and is stored in database 46. The ticket data is stored in the audit format in table L-TICKET; player data is stored in the audit format in table L-PLAYER; meter data is stored in the audit format in table L-SMD and jackpot data is stored in audit format in table L-JP. At regular time intervals, the poller function of the data mover in unit 40 moves the data from tables L-TICKET, L-PLAYER, L-SMD and L-JP in database 46 to corresponding tables RT-TICKET, RT-PLAYER, RT-SMD and RT-JP in database 24 through interface 48 and subnetwork 18. Moved data from tables L-TICKET, L-PLAYER, L-SMD and L-JP then are erased from database 46.

From time-to-time, the input data stored in database 24 may be required by game 100 or game 102. Such data periodically is copied from database 24 and is stored in database 46 by the data mover function of unit 40. For example, the data mover function of unit 40 may retrieve from database 24 ticket, player, meter and jackpot data originating from, gaming machines 100 and 102 played within the preceding 36 hours (or another time period) and store the data in database 46. As a result, the data will be readily available for use by gaming machines 100 and 102 even if central authority 22 is temporarily disabled.

As another example of input data, database 24 stores credit balances for many players in a table RT-BALANCES. The data mover function of unit 40 copies the RT-BALANCES table from database 24 and stores the data from the table in table L-BALANCES of database 46. When a player uses his club card 152, reader 150 reads the identification code on the card, and the data mover function of unit 40 addresses the credit balance corresponding to the identification code in the RT-BALANCES table of database 46. The player can continue his play with the proper credit reading even if central authority is temporarily disabled. Alternatively, the data mover can retrieve only the portion of the RT-BALANCES table for a predetermined preceding time period, such as 36 hours. As another alternative, the data mover can retrieve only the credit balance for the player whose card is placed in gaming machine 100.

As another example of input data, database 24 stores a table RT-TICKET of ticket values resulting from printing of tickets like 136 or 138 shown in FIG. 3. The data mover function of unit 40 copies the RT-TICKET table and stores the data from the table in the L-TICKET table of database 46.

The data mover also obtains from database 24 player name, point and comp balances, groups, preferences, player level, birthday and anniversary day. The data mover then updates the local databases 46 and 66 with this information.

Accounting workstation 132 uses gaming audit report generating software to generate reports of gaming activity by gaming machines 100-106. The software requires that the data in the tables of central database 24 be arranged in the audit format useable by the software. The transaction posting processes automatically post data in local databases 46 and 66 in the audit format required by the report generating software, thereby saving time and improving accuracy over the manual steps that have been required in the past. The data in the audit format is transferred at regular time intervals to database 24 for use by the audit report generating software.

While the invention has been described with reference to one or more preferred embodiments, those skilled in the art will understand that changes may be made and equivalents may be substituted without departing from the scope of the invention. In addition, many modifications may be made to adapt a particular step, structure, or material to the teachings of the invention without departing from its scope. Therefore, it is intended that the invention not be limited to the particular embodiment disclosed, but that the invention will include all embodiments falling within the scope of the appended claims.

1-39. (canceled)

40. A gaming system comprising:
a central authority including audit report software using a query language configured to access a plurality of interrelated tables stored in a first relational database in a first relational format, the plurality of interrelated tables including at least a remote meter table, a remote jackpot table, and a remote ticket table, wherein the plurality of interrelated tables store data corresponding to transactions taking place at both the first and second plurality of gaming machines; and
a data processing unit configured to communicate with the central authority over a network, wherein the data processing unit is configured to use digital meter data obtained from a plurality of gaming machines to generate a plurality of interrelated tables including at least a local meter table, a local jackpot table, and a local ticket table, wherein the plurality of interrelated tables are in a relational database format usable by the query language software to generate gaming audit reports, wherein the data processing unit is further configured to transmit, over the network, one or more of the plurality of interrelated tables to the central authority for storage in the relational database.

41. A gaming system comprising:
a plurality of gaming machines, each configured with a plurality of meters that each provide digital data corresponding to transactions that take place at the respective gaming machine, wherein the plurality of gaming machines are arranged into first and second groups;
a central authority;
a first relational database located in the central authority, wherein data stored in the first relational database is arranged in a relational format in a plurality of interrelated tables including at least a remote meter table, a remote jackpot table, and a remote ticket table;
gaming audit report software executed by a processor at the central authority, wherein the gaming audit report software is configured to access the first relational database using a query language to generate gaming audit reports;
first and second networks;
a data processing unit configured to communicate with the central authority over the first network, wherein the data processing unit comprises:
a polling unit configured to poll the first group of gaming machines over the second network to obtain the digital data from the plurality of meters of each gaming machine of the first group, wherein the digital data is in a data format that is unusable by the gaming audit report software, the polling unit being further configured to convert, without human intervention, the digital data obtained from the first group of gaming machines to generate a second relational database having a further plurality of interrelated tables corresponding to the interrelated tables of the first relational database, wherein the further plurality of interrelated tables include at least a local meter table, a local jackpot table, and a local ticket table in a second relational database format usable by the gaming audit report software; and
a data mover unit configured to transmit, over the first network, one or more of the further plurality of interrelated tables from the data processing unit to the central authority for storage in the first relational database, whereby one or more of the following actions are executed:
(1) data from the local meter table is stored in the remote meter table,
(2) data from the local jackpot table is stored in the remote jackpot table, or
(3) data from the local ticket table is stored in the remote ticket table.

42. The gaming system of claim 41, further comprising a processor arranged to manage polling operations of the polling unit.

43. The gaming system of claim 41, wherein the data mover unit is further configured to retrieve, from the first relational database, at least one of ticket data from the remote ticket table, jackpot data from the remote jackpot table, and meter data from the remote meter, wherein the retrieved data corresponds to data generated by the gaming machines within a predetermined preceding times.

44. A gaming system comprising:
a first plurality of gaming machines, each configured with a plurality of meters that each provide digital data corresponding to transactions that take place at the respective gaming machine;
a second plurality of gaming machines, each configured with a plurality of meters that each provide digital data corresponding to transactions that take place at the respective gaming machine;
a central authority including audit report software using a query language configured to access a plurality of interrelated tables stored in a relational database in a first relational format, the plurality of interrelated tables including at least a remote meter table, a remote jackpot table, and a remote ticket table, wherein the plurality of interrelated tables store data corresponding to transactions taking place at both the first and second plurality of gaming machines; and
a first data processing unit configured to communicate with the central authority over a first network, wherein the data processing unit is configured to:
poll the first plurality of gaming machines over a second network to obtain the digital data from the plurality of meters of each gaming machine of the first plurality of gaming machines, the first data processing unit being further configured to use the digital data obtained from the first plurality of gaming machines to generate a second plurality of interrelated tables including at least a first local meter table, a first local jackpot table, and a first local ticket table, wherein the second plurality of interrelated tables are in a relational database format accessible by the query language software to generate gaming audit reports;
wherein the data processing unit is further configured to transmit, over the first network, one or more of the second plurality of interrelated tables to the central authority for storage in the first relational database.

45. The gaming system of claim 44, wherein the central authority is configured to execute one or more of the following actions upon receipt of one or more of the second interrelated tables:
store data from the first local meter table in the remote meter table,
store data from the local jackpot table in the remote jackpot table, or
store data from the local ticket table in the remote ticket table.

46. The gaming system of claim 44, and further comprising a second data processing unit configured to:
communicate with the central authority over the first network:
poll the second plurality of gaming machines over a third network to obtain the digital data from the plurality of meters of each gaming machine of the second plurality of gaming machines, the second data processing unit being further configured to use the digital data obtained from the second plurality of gaming machines to generate a third plurality of interrelated tables including at least a second local meter table, a second local jackpot table, and a second local ticket table, wherein the third plurality of interrelated tables are in a relational database format accessible by the query language software to generate gaming audit reports; and
wherein the second data processing unit is further configured to transmit, over the first network, one or more of the third plurality of interrelated tables to the central authority for storage in the first relational database.

47. A method for use in a gaming system comprising:
generating a remote database at a central authority, the remote database including a plurality of interrelated tables stored in a relational format, the plurality of interrelated tables including at least a remote meter table, a remote jackpot table, and a remote ticket table;
accessing meter data from a plurality of gaming machines;
generating a local database at a data processing unit using the meter data from the plurality of gaming machines, the local database including a plurality of interrelated tables stored in the relational format, the plurality of interrelated tables including at least a local meter table, a local jackpot table, and a local ticket table;
transmitting one or more of the plurality of the interrelated tables of the local database to the central authority for inclusion in the remote database; and
accessing the remote database, including table data received from the local database, using query language software at the central authority to generate a gaming audit report.
